(19) United States
(12) Patent Application Publication
(10) Pub. No.: US 2026/0242054 A1
(43) Pub. Date: Aug. 20, 2026

(54) METHOD AND SYSTEM FOR DESATURATING CONTROL SURFACES OF AN AIRCRAFT, INCORPORATED IN ROLL KINEMATICS OF AN AIRCRAFT

(71) Applicant: Airbus Operations SAS, TOULOUSE (FR)

(72) Inventor: Julien BOSCHIAN, TOULOUSE (FR)

(21) Appl. No.: 19/539,356

(22) Filed: Feb. 13, 2026

(30) Foreign Application Priority Data
Feb. 19, 2025 (FR) FR2501714

(51) Int. Cl. B64C 13/18; B64C 9/00; B64C 9/12; B64C 13/16; B64C 13/50

(52) U.S. Cl. CPC B64C 13/18; B64C 9/00; B64C 9/12; B64C 13/16; B64C 13/503; B64C 13/505

(57) ABSTRACT

A method and system for desaturating primary control surfaces towards secondary control surfaces, incorporated in roll kinematics of an aircraft. The method involves: determining a first and a second commanded rolling moment to be applied to primary and, respectively, secondary control surfaces based on a first and, respectively, a second control law order to be realized by the primary and, respectively, secondary control surfaces; determining a first and, respectively, a second deflection angle of the respectively control surfaces based on the respective commanded rolling moments, and based on a non-linear conversion function; deflecting the control surfaces through the respective deflection angles.

### CROSS-REFERENCES TO RELATED APPLICATIONS

This application claims the benefit of French Patent Application Number FR2501714 filed on Feb. 19, 2025, the entire disclosure of which is incorporated herein by way of reference.

### FIELD OF THE INVENTION

The field of the present disclosure relates to a distribution function of a control law order on the different control surfaces available for realizing this control. This function is referred to as “roll kinematics” and makes it possible to realize the control of the aircraft about its roll axis.

### BACKGROUND OF THE INVENTION

In general, the control of the rolling movement of an aircraft implements the following three elements:
1) a control law, or flight control law, corresponding to a computer algorithm configured to determine, on the basis of a flight command issued by a pilot, or automatic pilot, the control law orders (for example in the form of a turning angle, or deflection angle, of the control surfaces) to be sent to a group of control surfaces of the aircraft in order to control the attitude and trajectory thereof;
2) roll kinematics of the aircraft corresponding to the translation or conversion of the control law order into deflection orders for the control surfaces. The purpose of these roll kinematics is to make it possible to calculate the control law orders to be provided to the ailerons and to the spoilers in order that the rolling moment applied to the aircraft corresponds to the commanded rolling moment. These roll kinematics thus fulfil two functions: (i) to distribute the control law orders, for the one part as a control law order to be provided to the ailerons, and for the other part as a control law order to be provided to the spoilers, for the deflection of these control surfaces and the realization of the rolling order of the aircraft, (ii) to determine the deflection angle to be applied to the ailerons and, respectively, to the spoilers depending on these control law orders provided to the ailerons and to the spoilers in order to linearize the moment generated by the control surfaces with respect to the control law order.
3) actuators which set the ailerons and the spoilers in motion in order to realize the control law orders and therefore the rolling order of the aircraft.

During rapid variations in the flight commands issued by a pilot, or the automatic pilot, if the control law orders to be realized by the ailerons correspond to a deflection speed of the ailerons greater than or equal to their maximum deflection speed (for example around 40°/s), the deflection of the ailerons that is realized does not correspond exactly to that commanded by the roll kinematics. Consequently, the rolling moment to be applied to the aircraft is no longer equal to that ordered by the control law. This results in saturation of the ailerons, and this can manifest itself as a phase difference between the actual rolling moment and the commanded rolling moment and therefore a reduction in control performance.

In order to counter this phenomenon of saturation of the ailerons, there exists a so-called “desaturation” function of the ailerons towards the spoilers. This function estimates the deflection not realized by the ailerons on account of their saturation, approximates the rolling moment to be applied to the ailerons, and retranslates this into an addition to the control law order to be realized by the spoilers. However, this approximation of the rolling moment to be applied to the ailerons is not exact since the change in the rolling moment depending on the deflections of the ailerons is not linear.

The situation can be improved. It is, in particular, desirable to provide a solution that makes it possible to improve the realization of the roll kinematics of an aircraft in the event of rapid variation in the flight commands causing saturation of the ailerons.

### SUMMARY OF THE INVENTION

Proposed here is a novel method for desaturating primary control surfaces towards secondary control surfaces, incorporated in roll kinematics of an aircraft, said aircraft being equipped with said primary control surfaces and said secondary control surfaces. The method is implemented in a system implemented in the form of electronic circuitry. The method involves: determining a first commanded rolling moment to be applied to said primary control surfaces and, respectively, a second commanded rolling moment to be applied to said secondary control surfaces on the basis of a first control law order to be realized by said primary control surfaces and, respectively, on the basis of a second control law order to be realized by said secondary control surfaces. The method also involves:
determining a first deflection angle of said primary control surfaces and, respectively, a second deflection angle of said secondary control surfaces on the basis of said first commanded rolling moment and, respectively, of said second commanded rolling moment, and on the basis of a non-linear conversion function, and
deflecting said primary control surfaces and, respectively, said secondary control surfaces through said first deflection angle and, respectively, through said second deflection angle.

Advantageously, it is possible to improve the realization of the roll kinematics of the aircraft by taking into account the non-linearity between the turning angle of the ailerons and the corresponding rolling moment.

According to one embodiment, the method also involves, when said primary control surfaces are incapable of realizing said first commanded rolling moment:
measuring an actual turning angle of said primary control surfaces,
determining, from said measured actual turning angle, an actual rolling moment for said primary control surfaces,
determining, from said first commanded rolling moment and from said actual rolling moment, a rolling moment not realized by said primary control surfaces,
determining a turning angle of said secondary control surfaces from said rolling moment not realized by said primary control surfaces and said second commanded rolling moment, said unrealized rolling moment and said second commanded rolling moment supplying said non-linear conversion function in order to determine said turning angle of said secondary control surfaces.

Advantageously, this non-linear conversion function, or desaturation function no longer works on the basis of deflections commanded by the roll kinematics, but on the basis of rolling moments that will be required for the ailerons and for the spoilers. Thus, regardless of the current position of the ailerons and of the spoilers, this function will quantify the rolling moment that is not realized by the ailerons on account of their saturation, and require the addition of this same rolling moment to that ordered for the spoilers. The deflection to be added to the spoilers can thus be determined in order to realize this rolling moment.

According to one embodiment, said non-linear conversion function is based on a table correlating a plurality of aerodynamic parameters of said aircraft with a rolling moment for said primary control surfaces and, respectively, for said secondary control surfaces.

According to one embodiment, at least one other control law order is combined with said first control law order and/or with said second control law order.

Also proposed here is a system for desaturating primary control surfaces towards secondary control surfaces, incorporated in roll kinematics of an aircraft, said aircraft being equipped with said primary control surfaces and second secondary control surfaces. The system comprises electronic circuitry configured to:
determine a first commanded rolling moment to be applied to said primary control surfaces and, respectively, a second commanded rolling moment to be applied to said secondary control surfaces on the basis of a first control law order to be realized by said primary control surfaces and, respectively, on the basis of a second control law order to be realized by said secondary control surfaces. The system also comprises electronic circuitry configured to:
   determine a first deflection angle of said primary control surfaces and, respectively, a second deflection angle of said secondary control surfaces on the basis of said first commanded rolling moment and, respectively, of said second commanded rolling moment, and on the basis of a non-linear conversion function, and,
deflect said primary control surfaces and, respectively, said secondary control surfaces through said first deflection angle and, respectively, through said second deflection angle.

Also proposed here is an aircraft comprising a system as described above.

Also proposed is a computer program product comprising instructions causing a processor to execute the method set out above according to any one of its embodiments when said instructions are read and executed by the processor.

Also proposed is a storage medium storing such instructions causing the processor to execute the method set out above according to any one of its embodiments when said instructions are read from the storage medium and executed by the processor.

### BRIEF DESCRIPTION OF THE DRAWINGS

The abovementioned features of the invention, and others, will become more clearly apparent from reading the following description of at least one exemplary embodiment, said description being given with reference to the appended drawings, in which:

FIG. 1 schematically illustrates a side view of an aircraft equipped with a system for controlling the aircraft about its roll axis, according to one embodiment;

FIG. 2 schematically illustrates an example of the hardware architecture of a system for controlling the aircraft about its roll axis, including the roll kinematics of an aircraft, according to one embodiment;

FIG. 3 illustrates, in the form of a diagram, the steps of a method for desaturating primary control surfaces towards secondary control surfaces, incorporated in roll kinematics of an aircraft, according to one embodiment;

FIG. 4 illustrates, in the form of a graph, an example of the distribution of a control law order between the ailerons and the spoilers as known from the prior art.

### DETAILED DESCRIPTION OF THE PREFERRED EMBODIMENTS

FIG. 1 thus schematically illustrates a side view of an aircraft 100 equipped with a system 101 for desaturating primary control surfaces towards secondary control surfaces, incorporated in roll kinematics of an aircraft (also referred to below as system for controlling the aircraft about its roll axis or system 101), according to one embodiment of the roll kinematics.

The system 101 is electronic equipment installed on-board the aircraft 100. For example, the system 101 is part of the electronic circuitry of the avionics of the aircraft 100. For example, the system 101 is incorporated into the flight control computers of the aircraft 100. The flight control computers are configured to transmit a control law order (for example in the form of a turning angle or deflection angle of the control surfaces) to the actuators, which then deflect control surfaces of the aircraft 100. In particular, the flight control computers are configured to receive the positions of the pilot's flight commands (for example mini stick), and data originating from the sensors of the aircraft (for example inertial systems, pitot tubes, etc.). The orders of the automatic pilot are also collected. All of these parameters are processed by the flight control laws in order to formulate orders sent to the actuators of each control surface.

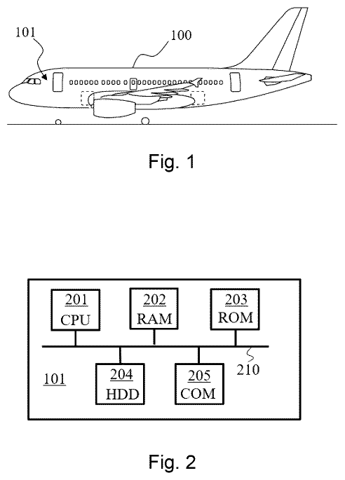

FIG. 2 schematically illustrates an example of a hardware platform for implementing, in the form of electronic circuitry, the system 101, according to one embodiment.

The hardware platform comprises, connected by a communication bus 210, a processor or CPU (Central Processing Unit) 201; a RAM (Random-Access Memory) 202; a ROM (Read Only Memory) or EEPROM (Electrically-Erasable Programmable ROM), such as a Flash memory, 203; a storage unit such as an HDD (Hard Disk Drive) 204, or a storage medium reader, such as an SD (Secure Digital) card reader; and a COM interface handler 205.

The COM interface handler 205 allows the system 101 to interact with the avionic systems of the aircraft 100, such as: the flight control computers, the sensors, etc.

The processor 201 is capable of executing instructions which form a computer program and which are loaded into the RAM 202 from the ROM 203, from an external memory, from a storage medium (such as an SD card) or from a communication network. When the hardware platform is powered up, the processor 201 is capable of reading the abovementioned instructions from the RAM 202 and executing them. When they are read from the RAM 202 or a storage medium and executed by the processor 201, these instructions (which form a computer program) cause the processor 201 to execute all or some of the steps or methods or more broadly operating sequences of the aircraft that are described in the present description.

All or some of the steps, methods and operations described herein can thus be implemented in the form of software by the execution of a set of instructions by a programmable machine, for example a processor of the DSP (Digital Signal Processor) type or a microcontroller, or be implemented in the form of hardware by a machine or a dedicated electronic component (chip) or a dedicated set of electronic components (chipset), for example an FPGA (Field Programmable Gate Array) or ASIC (Application Specific Integrated Circuit) component. Generally, the system 101 comprises electronic circuitry that is suitable and configured for implementing all or some of the operations, methods and steps described herein.

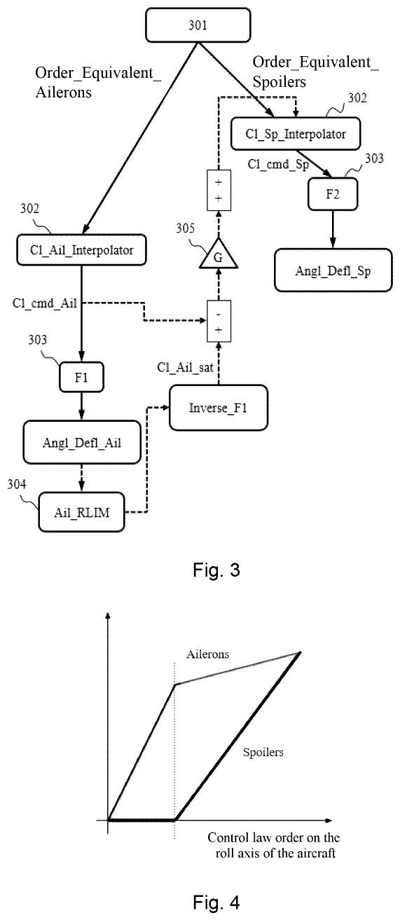

FIG. 3 illustrates, in the form of a diagram, steps of a method for realizing roll kinematics of an aircraft 100, showing a method for desaturating primary control surfaces (for example ailerons) towards secondary control surfaces (for example spoilers), incorporated in roll kinematics of an aircraft 100, according to one embodiment. All or part of this method is implemented by the above-described system 101. It should be noted that the term “incorporated” is understood to mean that the desaturation method according to the invention is added to or incorporated in a coordinated manner into the roll control mechanism of the aircraft, i.e., into the roll kinematics for optimal management of the maneuvers of the aircraft 100.

During a step 301, the system 101 receives a flight command issued by a pilot or an automatic pilot. This flight command is, for example, a command intended to set the aircraft 100 into rotational motion about its roll axis. A control law is then executed in order to determine a commanded control law (for example in the form of a turning angle or deflection angle of the control surfaces) for setting the control surfaces, such as the ailerons and the spoilers of the aircraft 100, into motion.

Following this step 301, the commanded control law order is distributed between a first control law order (Order_Equivalent_Ailerons) to be realized by primary control surfaces, such as the ailerons, and a second control law order (Order_Equivalent_Spoilers) to be realized by the secondary control surfaces, such as the spoilers. These first and second control law orders are expressed as so-called “lateral control” orders. This lateral control order is given in terms of rolling moment. In other words, a lateral control order represents the quantity of rolling moment (dimensionless value) for the aerodynamic capability of the aircraft 100.

This distribution of the commanded control law order between the first and the second control law orders is realized in a known and arbitrary manner, for example, in order to take into account the flight quality of the aircraft 100, the pilot's perception, etc. For example, conventionally, the low commanded control law orders are generally converted exclusively or almost exclusively into control law orders for the deflection of the ailerons, and control law orders for the deflection of the spoilers are gradually added when the commanded control law orders become higher. FIG. 4 illustrates, in the form of a graph, an example of the distribution of a control law order, corresponding to a rolling order of the aircraft 100, between the ailerons and the spoilers. According to this example, the ailerons are deployed before the spoilers depending on the rolling order originating from the control law.

During a step 302, the system 101 converts the first and second control law orders into commanded rolling moments for the primary and secondary control surfaces (i.e. ailerons and spoilers). For this, the system 101 executes a so-called “linear conversion” function, which is a linear function for converting a control law order applied to the ailerons and, respectively, the spoilers into a rolling moment to be applied to the ailerons and, respectively the spoilers. This linear conversion function to be applied to the ailerons (Cl_Ail_Interpolator) and, respectively, the spoilers (Cl_Sp_Interpolator) takes as input the first control law order for the primary control surfaces (Order_Equivalent_Ailerons) and, respectively, the second control law order for the secondary control surfaces (Order_Equivalent_Spoilers). In one example, the first control law order for the primary control surfaces (Order_Equivalent_Ailerons) is a dimensionless value lying in a range of values delimited by a minimum value, denoted Min, and a maximum value, denoted Max, for example [−20, +20]. This dimensionless value is, for example, similar to a turning angle of a flight command by the pilot in the cockpit of the aircraft 100. By sign convention, −20 (order_equivalent_min) corresponds to a direction of the aircraft 100 turning to the right, and conversely, +20 corresponds to a direction of the aircraft 100 turning to the left. The ailerons can rotate (deflection angle) between a minimum angular value, denoted angle_min, and a maximum angular value, denoted angle_max, which generally lie on either side of an angular value of 0 degrees.

The resulting rolling moment value of the ailerons is denoted Cl_max for the right-hand aileron, ranging down to its minimum angular value angle_min (i.e. upward deflection of the right-hand aileron), and the left-hand aileron, ranging up to its maximum angular value angle_max (i.e. downward deflection of the left-hand aileron). Cl_min is the opposite value to Cl_max, obtained when the left-hand aileron is at its minimum angular value angle_min and the right-hand aileron is at its maximum angular value angle_max.

The resulting rolling moment value of the ailerons, for a deflection corresponding to an angle of 0 degrees, is zero. By sign convention, Cl_max corresponds to a direction of turning to the right.

Thus, this linear conversion function executed by the system 101 makes it possible to obtain the following relationship between the input corresponding to a control law order to be realized by the ailerons (Order_Equivalent_Ailerons) and the output corresponding to a commanded rolling moment to be applied to the ailerons (cl_cmd_ail), such that:
when the left-hand aileron is at its minimum angular value angle_min and the right-hand aileron is at its maximum angular value angle_max, cl_cmd_ail=cl_min;
when the left-hand and right-hand ailerons are at an angular value of zero, cl_cmd_ail=0;
when the right-hand aileron is at its minimum angular value angle_min and the left-hand aileron is at its maximum angular value angle_max, cl_cmd_ail=cl_max.

For example, for turning of the aircraft 100 to the right, with the relationship being linear:

$$cl\_cmd \_ail ( 0.5 \times order\_Equivalent \_Ailerons \_Min ) = 0.5 \times cl\_max$$

Optionally, other control law orders to be realized with the ailerons can be added to the control law order originating from the control law executed, at the start of step 302, in order to realize the mixing of different functions (LAF or Load Alleviation Function, referred to as “Droop” or “Aileron lift increasing function”, etc.). These different functions that have an impact on the neutral position of the ailerons are considered in order to maintain a coherent distribution of ailerons and spoilers and proper linearization of the control surface moments with respect to the law order.

The addition of these control law orders at this level makes it possible to ensure the linearity of the kinematics for the overall control law order thus determined.

The system 101 executes a similar linear conversion function (Cl_Spoilers_Interpolator) for the secondary control surfaces (i.e. spoilers).

This makes it possible to have a linear relationship between the control law order to be realized by the ailerons and the rolling effectiveness of the ailerons, expressed in terms of rolling moment. It should be noted that the relationship between the turning angle of the ailerons and the corresponding rolling moment is not linear.

Thus, during a step 303, the system 101 converts the commanded rolling moment to be applied to the ailerons (Cl_cmd_Ail) and, respectively, to the spoilers (Cl_cmd_Sp) into commanded angular deflection of the primary control surfaces (i.e. ailerons) and, respectively, of the secondary control surfaces (i.e. spoilers) according to a so-called “non-linear conversion” function to be applied to the ailerons, denoted F1, and, respectively, to be applied to the spoilers, denoted F2.

In particular, the commanded rolling moment to be applied to the ailerons (Cl_cmd_Ail) and, respectively, to be applied to the spoilers (Cl_cmd_Sp) is converted into a commanded angular deflection of the ailerons (Angl_Defl_Ail) and, respectively, of the spoilers (Angl_Defl_Sp). In other words, the non-linear conversion function F1, to be applied to the commanded rolling moment of the ailerons, is a non-linear function which makes it possible to convert the commanded rolling moment of the ailerons (cl_cmd_ail) into a commanded angular deflection (Angl_Defl_Ail).

This non-linear conversion function F1 is implemented in a so-called “tabulated” manner, i.e., using a table having as input parameters a set of aerodynamic parameters of the aircraft 100 (for example Mach number, altitude, angle of attack, configuration of the slats and flaps, etc.) for a set of commanded rolling moment values of the ailerons lying between Cl_min and Cl_max. A linear interpolation can be carried out for the commanded rolling moment values lying between two commanded rolling moment values belonging to this set of values. In a particular manner, this table is determined on the basis of measurements taken during flight tests on the aircraft 100 under consideration or on an aircraft of the same type.

In the same way, the non-linear conversion function to be applied to the spoilers F2 in order to convert the commanded rolling moment of the spoilers (Cl_cmd_Sp) into a commanded angular deflection (Angl_Defl_Sp) is a non-linear function, implemented in a tabulated manner. The corresponding table is also determined on the basis of measurements taken during flight tests on the aircraft 100 under consideration or on an aircraft of the same type.

As described above, the ailerons cannot exceed a maximum speed of rotation during their maneuvers, for example 40°/second. Thus, during rapid variations in the control law order, the commanded deflection of the ailerons may become saturated (Ail_RLIM) and consequently not generate the rolling moment expected by the control law. Thus, during a step 304, when the ailerons are saturated on account of a rapid variation in the control law order, the actual angular position of the ailerons is measured.

By inverting the table corresponding to the non-linear conversion function to be applied to the ailerons F1 (Inverse_F1), it is possible to determine the actual rolling moment (Cl_ail_sat) resulting from said actual angular position of the ailerons. In contrast to the commanded rolling moment (cl_cmd_ail) determined at the end of step 302, it is possible determine the so-called “unrealized” rolling moment, or rolling moment delta, on account of the saturation of the ailerons.

The use of conversion tables between the commanded rolling moment and the angular deflection of the ailerons, and vice versa, allows a precise conversion between the values of said parameters. As a result, the rolling moment delta is determined precisely.

During a step 305, the rolling moment delta, or rolling moment not realized by the ailerons, is converted into a control law order to be realized by the spoilers in order to compensate for this limitation of the ailerons. This is realized by applying to this rolling moment delta a gain G corresponding to the slope of the change in the rolling moment to be applied to the spoilers depending on the control law order to be realized by the spoilers (Order_Equivalent_Spoilers). It makes it possible to convert or translate the unrealized rolling moment into a control law order to be realized by the spoilers.

The control law order thus determined is added to the control law order to be realized by the spoilers (Order_Equivalent_Spoilers) that originates from the control law, as determined in step 301. In the same way as for the ailerons, other, optional control law orders to be realized by spoilers can be added at this level so as to ensure the linearity of the relationship between the rolling moment commanded by the spoilers and the overall control law order thus determined.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for desaturating primary control surfaces towards secondary control surfaces, incorporated in roll kinematics of an aircraft, said aircraft equipped with said primary control surfaces and said secondary control surfaces, said method being implemented in a system implemented comprising electronic circuitry, and said method comprising:
determining a first commanded rolling moment to be applied to said primary control surfaces and, respectively, a second commanded rolling moment to be applied to said secondary control surfaces based on a first control law order to be realized by said primary control surfaces and, respectively, based a second control law order to be realized by said secondary control surfaces;
determining a first deflection angle of said primary control surfaces and, respectively, a second deflection angle of said secondary control surfaces based on said first commanded rolling moment and, respectively, of said second commanded rolling moment, and based on a non-linear conversion function, and
deflecting said primary control surfaces and, respectively, said secondary control surfaces through said first deflection angle and, respectively, through said second deflection angle; and,
when said primary control surfaces are incapable of realizing said first commanded rolling moment,
measuring an actual turning angle of said primary control surfaces,
determining, from said actual turning angle that was measured, an actual rolling moment for said primary control surfaces,
determining, from said first commanded rolling moment and from said actual rolling moment, a rolling moment not realized by said primary control surfaces, and
determining a turning angle of said secondary control surfaces from said rolling moment not realized by said primary control surfaces and said second commanded rolling moment, said rolling moment not realized and said second commanded rolling moment supplying said non-linear conversion function in order to determine said turning angle of said secondary control surfaces.

2. The method according to claim 1, wherein said non-linear conversion function is based on a table correlating a plurality of aerodynamic parameters of said aircraft with a rolling moment for said primary control surfaces and, respectively, for said secondary control surfaces.

3. The method according to claim 1, wherein at least one other control law order is combined with said first control law order, or with said second control law order, or both.

4. A system for desaturating primary control surfaces towards secondary control surfaces, incorporated in roll kinematics of an aircraft, said aircraft being equipped with said primary control surfaces and second secondary control surfaces, said system comprising electronic circuitry configured to:
determine a first commanded rolling moment to be applied to said primary control surfaces and, respectively, a second commanded rolling moment to be applied to said secondary control surfaces based on a first control law order to be realized by said primary control surfaces and, respectively, based on a second control law order to be realized by said secondary control surfaces;
determine a first deflection angle of said primary control surfaces and, respectively, a second deflection angle of said secondary control surfaces based on said first commanded rolling moment and, respectively, of said second commanded rolling moment, and based on a non-linear conversion function; and,
deflect said primary control surfaces and, respectively, said secondary control surfaces through said first deflection angle and, respectively, through said second deflection angle,
wherein said electronic circuitry is also configured to, when said primary control surfaces are incapable of realizing said first commanded rolling moment:
measure an actual turning angle of said primary control surfaces,
determine, from said actual turning angle, an actual rolling moment for said primary control surfaces,
determine, from said first commanded rolling moment and from said actual rolling moment, a rolling moment not realized by said primary control surfaces, and
determine a turning angle of said secondary control surfaces from said rolling moment not realized by said primary control surfaces and said second commanded rolling moment, said rolling moment not realized and said second commanded rolling moment supplying said non-linear conversion function to determine said turning angle of said secondary control surfaces.

5. An aircraft comprising:
the system according to claim 4.

6. A non-transitory computer readable medium storing a computer program product comprising instructions which, when executed by a processor, execute the method according to claim 1.
